(19) United States
(12) Patent Application Publication
(10) Pub. No.: US 2022/0107062 A1
(43) Pub. Date: Apr. 7, 2022

(54) FLEXIBLY DEFORMABLE HARD LINEAR LAMP

(71) Applicant: FORMA LIGHTING (HK) LIMITED, QUARRY BAY (HK)

(72) Inventor: MICHAEL MONSONEGO, QUARRY BAY (HK)

(21) Appl. No.: 17/429,660

(22) PCT Filed: Mar. 12, 2020
(86) PCT No.: PCT/CN2020/078930

§ 371 Date: Aug. 10, 2021

(30) Foreign Application Priority Data
Mar. 14, 2019 (CN) 201920335861.3

(51) Int. Cl. F21S 4/22; F21S 8/00; F21V 17/16; F21V 21/005; F21V 21/02; F21V 29/76

(52) U.S. Cl. CPC F21S 4/22; F21S 8/036; F21V 17/164; F21Y 2115/10; F21V 21/025; F21V 29/767; F21V 21/005

(57) ABSTRACT

The present utility model provides a flexibly deformable hard linear lamp, which comprises a plurality of light source assemblies and connection assemblies connecting the light source assemblies. The connection assemblies are flexibly snap-fitted into the through holes at adjacent ends of adjacent light source assemblies, so that both the spacing and included angle of two adjacent light source assemblies can be adjusted within a certain range. Therefore, the deformation angle is flexible and the length varies flexibly; and a single lamp can meet the deformation requirements, so that the cost is reduced, and at the same time the wiring is simple and aesthetic; the spacing of adjacent light sources may be consistent, so that the light spots are evenly distributed, and there is favorable light effect. It is suitable for both specially shaped projects and large-scale commercial lighting projects.

### TECHNICAL FIELD

The present utility model relates to the field of LED linear lamp, in particular to a flexibly deformable hard linear lamp.

### BACKGROUND ART

The LED linear lamp is a high-end linear decorative lamp, which has the prominent characteristics of low power consumption, long service life, high brightness, easy bending, and maintenance-free. It is particularly suitable for indoor and outdoor entertainment venues, building outline sketching, billboard fabrication, and the like. However, the current ordinary hard linear lamps on the market cannot favorably meet the lighting requirements of arc-shaped or irregular linear areas.

In a lighting environment that requires arc-shaped or irregular linear areas, a common practice at present is to connect a plurality of lamps having a short length in series from end to end.

However, there are following defects: 1. with the use of a large number of lamps, the overall cost is high, and at the same time the wiring is complicated; 2. it is difficult to maintain a consistent distance between two adjacent lamps, so that the light spots formed by diffusion of different point light sources are messy and disordered, and it is thus difficult to obtain an orderly and aesthetic light effect and light sense; 3. the connection between various lamps to be connected in series is likely to be malfunctioned, and causes chain problems with other lamps.

Therefore, there is an urgent need to design a hard linear lamp that can overcome the above-described defects and favorably meet the lighting requirements of arc-shaped or irregular linear areas.

### SUMMARY OF THE UTILITY MODEL

In order to solve the above-described problem, the present utility model provides a flexibly deformable hard linear lamp suitable for arc-shaped or irregular linear lighting occasions.

According to a first aspect of the present utility mode, a flexibly deformable hard linear lamp is provided, which comprises: a plurality of light source assemblies including a lamp housing and a light emitting assembly accommodated within the lamp housing, wherein a first through hole is provided at both ends of the light source assembly; a connection assembly movably connected between two adjacent light source assemblies, wherein the connection assembly includes a connecting piece and a fastener disposed at both ends of the connecting piece, wherein the fastener is snap-fitted into the inside of the first through hole of the light source assembly, so that the spacing and included angle between two adjacent light source assemblies are adjustable.

In the flexibly deformable hard linear lamp according to the first aspect of the present utility mode, the connecting piece has a width less than that of the first through hole, and the connecting piece has a height less that that of the first through hole.

In the flexibly deformable hard linear lamp according to the first aspect of the present utility mode, a second through hole to accommodate an electric wire and to allow the electric wire to pass therethrough is provided at both ends of the light source assembly.

In the flexibly deformable hard linear lamp according to the first aspect of the present utility mode, an arc-shaped protrusion to facilitate heat dissipation is provided at both sides of the lamp housing, wherein the arc-shaped protrusion is evenly provided with a plurality of strip-like grooves into which an elastic piece for installation could be snap-fitted.

In the flexibly deformable hard linear lamp according to the first aspect of the present utility mode, the lamp housing includes a lamp cover removably connected to both ends of the lamp housing, wherein a cavity to accommodate the faster and to allow the movement of the fastener therein is provided at a position within the light source assembly proximate to the lamp cover.

In the flexibly deformable hard linear lamp according to the first aspect of the present utility mode, a plurality of radiating fins perpendicular to the lamp cover are evenly arranged below the lamp housing.

In the flexibly deformable hard linear lamp according to the first aspect of the present utility mode, the light emitting assembly includes an aluminum PCB fixed on the radiating fin, an LED soldered on the aluminum PCB, a cylindrical lens housing located above the LED and a lens accommodated within the lens housing.

In the flexibly deformable hard linear lamp according to the first aspect of the present utility mode, an annular protrusion is provided on a top edge of the lens, and an annular groove and a buckle corresponding to the annular protrusion are provided inside a top of the lens housing, so that the lens housing is fixed with the lens by snap-fitting.

In the flexibly deformable hard linear lamp according to the first aspect of the present utility mode, the fastener includes a fixing screw, a wave washer, a plain washer, a gasket and an antiskid nut.

The present utility model has the following advantageous effects: the present utility model provides a flexibly deformable hard linear lamp, which comprises a plurality of light source assemblies and a connection assembly connecting the light source assemblies. The connection assembly is flexibly snap-fitted into the through hole at adjacent ends of adjacent light source assemblies, so that both the spacing and included angle of two adjacent light source assemblies can be adjusted within a certain range. Therefore, the deformation angle is flexible and the length varies flexibly; a single lamp can meet the deformation requirements, so that the cost is reduced, and at the same time the wiring is simple and aesthetic; the spacing of adjacent light sources may be consistent, so that the light spots are evenly distributed, and there is favorable light effect. It is suitable for both specially shaped projects and large-scale commercial lighting projects.

### BRIEF DESCRIPTION OF THE DRAWINGS

In order to explain the technical solution in the embodiments of the present utility model more clearly, the accompanying drawings required to be used in the description of the embodiments will be briefly described below. Obviously, the accompanying drawings described are only a part of the embodiments of the present utility model, but not all the embodiments. Those skilled in the art may also obtain other design solutions and accompanying drawings based on these drawings on the premise that no inventive effort is involved.

FIG. 1 is a schematic view of an overall structure in a linear state according to a first embodiment of the present utility model;

FIG. 2 is a schematic view of an overall structure in a curved state according to a first embodiment of the present utility model;

FIG. 3 is a first schematic view of an exploded structure in a curved state according to a first embodiment of the present utility model;

FIG. 4 is a schematic side view in a linear state according to a first embodiment of the present utility model;

FIG. 5 is a second schematic view of an exploded structure in a curved state according to a first embodiment of the present utility model;

FIG. 6 is a first schematic view of an exploded structure of a light source assembly according to a first embodiment of the present utility model;

FIG. 7 is a second schematic view of an exploded structure of a light source assembly according to a first embodiment of the present utility model;

FIG. 8 is a schematic view of an exploded structure in a curved state according to a second embodiment of the present utility model.

### DETAILED EMBODIMENTS

In this section, the specific embodiments of the present utility model will be described in detail. The preferred embodiments of the present utility model will be shown in the accompanying drawings, which function to supplement the description of a literal portion of the specification using the drawings, so that each technical feature and the overall technical solution of the present utility model can be perceptibly and visually understood, but cannot be understood as a limitation on the protection scope of the present utility model.

In the description of the present utility model, it is necessary to understand that, when there involves the description of orientation, the orientation or position relationship for example indicated by upper, lower, front, rear, left and right which is based on the orientation or position relationship shown in the accompanying drawings, is only to facilitate description of the present utility model and simplify the description, rather than to indicate or imply that the device or element referred thereto must have a specific orientation and is configured and operated in a specific orientation, and therefore cannot be understood as a limitation on the present utility model.

In the description of the present utility model, the meaning of the expression “a plurality of” is one or more, and the meaning of the expression “more” is more than two. The expressions such as “more than”, “less than”, and “exceeding” do not include this number, and the expression “or more”, “or less” and “within” include this number. The expressions of “first” and “second”, if any, are only intended to distinguish the technical features, but cannot be understood as indicating or implying relative importance or implicitly indicating the number of the technical features as indicated or the sequence of the technical features as indicated.

In the description of the present utility model, unless clearly defined otherwise, the words such as “provided”, “mounted” and “connected” should be understood in a broad sense, and those skilled in the art may reasonably determine the specific meanings of the above-described words in the present utility model in conjunction with the specific content of the technical solution.

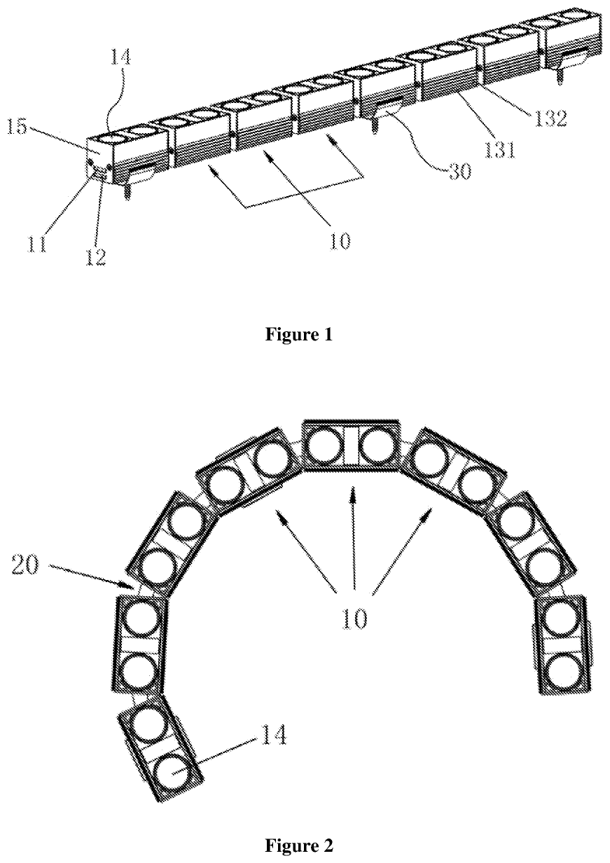

FIGS. 1 to 7 show a flexibly deformable hard linear lamp according to a first embodiment of the present utility model, comprising: a plurality of light source assemblies 10 including a lamp housing 13 and a light emitting assembly 14 accommodated within the lamp housing 13, wherein the light source assembly 10 is provided with a first through hole 11 at both ends thereof; a connection assembly 20 movably connected between two adjacent light source assemblies 10, the connection assembly 20 including a connecting piece 21 and a fastener 22 provided at both ends of the connecting piece 21, wherein the fastener 22 is snap-fitted into an inside of the first through hole 11 of the light source assembly 10, so that the spacing and included angle between two adjacent light source assemblies 10 can be adjusted.

The present utility model provides a flexibly deformable hard linear lamp, comprising a plurality of light source assemblies 10 and a connection assembly 20 connecting the light source assemblies 10. The connection assembly 20 is flexibly snap-fitted into the first through hole 11 at adjacent ends of adjacent light source assemblies 10, so that both the spacing and included angle of two adjacent light source assemblies 10 can be adjusted within a certain range. Therefore, the deformation angle is flexible and the length varies flexibly; a single lamp can meet the deformation requirements, so that the cost is reduced, and at the same time the wiring is simple and aesthetic; the spacing of adjacent light sources may be consistent, so that the light spots are evenly distributed, and there is favorable light effect. It is suitable for both specially shaped projects and large-scale commercial lighting projects.

The first embodiment of the present utility model will be specifically described below.

Referring to FIG. 1, FIG. 1 is a schematic view of an overall structure in a normal state according to a first embodiment of the present utility model. The present utility model may be formed by connecting eight identical light source assemblies 10 shown in FIG. 1. In a normal state, the connected eight identical light source assemblies 10 maintain the same spacing and the same included angle (0 degree), so that the entire lamp presents an elongated shape. The spacing between adjacent light source assemblies 10 is still maintained consistent, so that the light spots are evenly distributed, and there is a favorable light effect.

Referring to FIG. 1, the light source assembly 10 is provided with a second through hole 12 to accommodate an electric wire and to allow the electric wire to pass therethrough. Therefore, the electric wire may pass through the second through hole 12 and connect respective light source assemblies 10, so that the hard linear lamp of the present utility model has a simple and aesthetic wiring.

In addition, the lamp housing 13 is provided with an arc-shaped protrusion 131 that facilitates heat dissipation on both sides thereof, so as to optimize the heat dissipation effect of the hard linear lamp of the present utility model. The arc-shaped protrusion 131 is evenly provided with a plurality of strip-like grooves 132, so that an elastic piece 30 for installation can be snap-fitted and fixed to the strip-like groove 132. The specific installation manner will be described later in conjunction with FIG. 4.

Referring to FIG. 2, FIG. 2 is a schematic view of an overall structure in a curved state according to the first embodiment of the present utility model. The lamp formed by connecting eight identical light source assemblies 10 shown in FIG. 1 may be curved into a state shown in FIG. 2 by adjusting an included angle between adjacent light source assemblies 10. At this time, the spacing between adjacent light source assemblies 10 is still maintained consistent, so that the light spots are evenly distributed and there is a favorable light effect.

Obviously, if different numbers of light source assemblies 10 are selected, hard linear lamps having different lengths may be obtained. On such basis, the spacing and angle between adjacent light source assemblies 10 may be adjusted to obtain hard linear lamps with various different shapes (e.g., “S”, “J”), so as to be adapted for arc-shaped or irregular linear lighting occasions. The hard linear lamps adjusted into various shapes may be understood in conjunction with the first embodiment of the present utility model, and thus will not be described further herein.

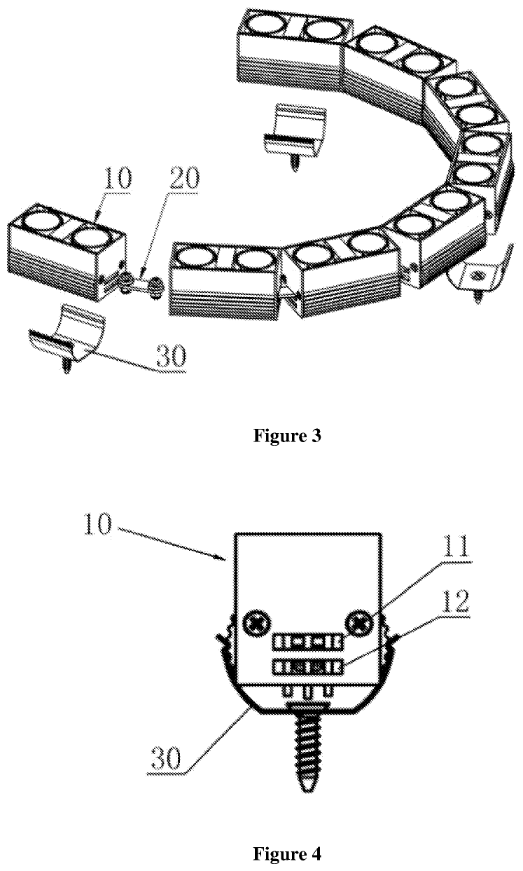

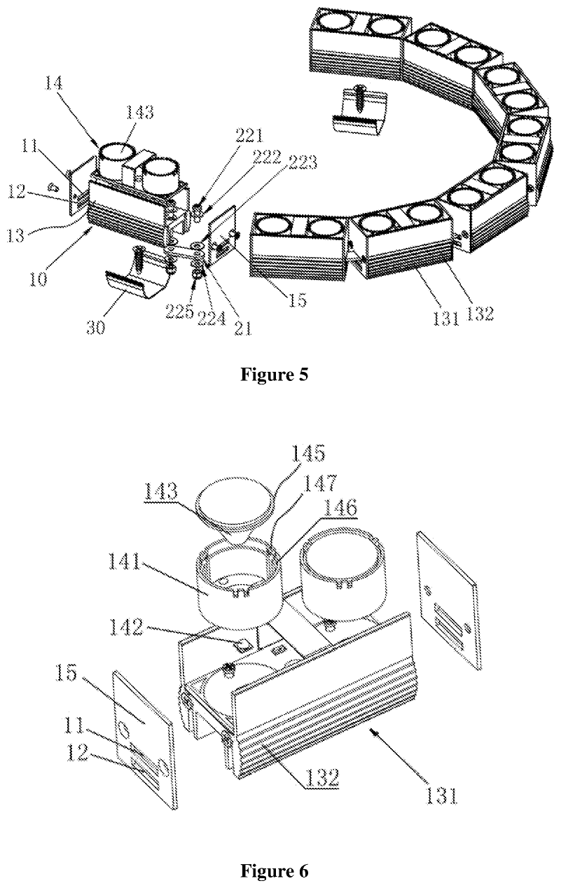

Referring to FIG. 3, FIG. 3 is a first schematic view of an exploded structure in a curved state according to the first embodiment of the present utility model. The connection assembly 20 is flexibly snap-fitted into the first through hole 11 of adjacent light source assemblies 10 through a fastener 22 at both ends of the connection assembly. Therefore, the spacing and angle between adjacent light source assemblies 10 may be flexibly adjusted. The connection manner thereof will be described in more detail in conjunction with FIG. 5.

Referring to FIG. 5, FIG. 5 is a second schematic view of an exploded structure in a curved state according to the first embodiment of the present utility model. The fastener 22 includes a fixing screw 221, a wave washer 222, a plain washer 223, a gasket 224, and an antiskid nut 225. During assembling, the connecting piece 21 is first passed through the first through hole 11 in lamp covers 15 at adjacent ends of adjacent light source assemblies 10, and then the fixing screw 221, the wave washer 222, the plain washer 223, the gasket 224 and the antiskid nut 225 described above are assembled into a fastener 22, which is mounted at both ends of the connection assembly 20, and at the same time snap-fitted into an inside of the lamp cover 15 of the light source assembly 10. Since the width of the connecting piece 21 is less than that of the first through hole 11 and the height of the connecting piece 21 is less than that of the first through hole 11, the connection assembly 20 may adjust the angle and the exposed length within a certain range, thereby realizing the adjustment of the spacing and angle between adjacent light source assemblies 10.

Referring to FIG. 4, FIG. 4 is a schematic side view in a normal state according to the first embodiment of the present utility model. The hard linear lamp in the present utility model may be fixedly mounted on a contact surface such as a wall surface through the elastic piece 30. Specifically, the elastic piece 30 is first fixedly mounted on a contact surface such as a wall surface with a screw in the middle, and then the elastic piece 30 is snap-fitted and fixed to the arc-shaped protrusion 131 of the strip-like groove 132 in the lamp housing 13, so as to achieve the fixation of the elastic piece 30, the light source assembly 10 and the hard linear lamp, thereby fixedly mounting the hard linear lamp on the contact surface such as a wall surface.

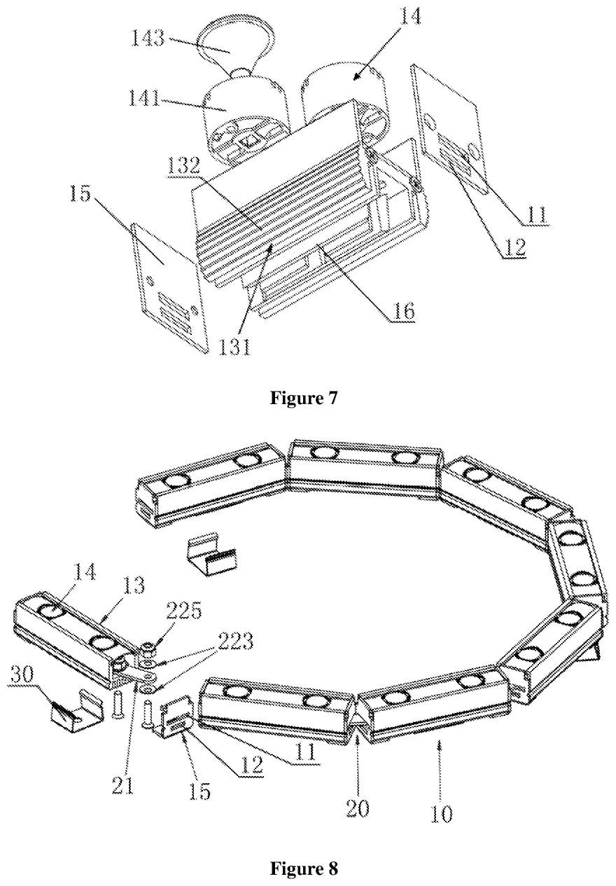

Referring to FIGS. 6 and 7, FIGS. 6 and 7 are respectively two schematic views of an exploded structure of a light source assembly according to the first embodiment of the present utility model. The lamp housing 13 includes a lamp cover 15 detachably connected to both ends of the lamp housing 13. A cavity to accommodate the fastener 22 and to allow the movement of fastener 22 is provided at a position within the light source assembly 10 proximate to the lamp cover 15. The light emitting assembly 14 is designed to have a size matching the cavity, so that the light emitting assembly 14 can be stably accommodated within the lamp housing 13.

The light emitting assembly 14 includes a cylindrical lens housing 141, an LED 142 disposed on the bottom of the lens housing 141, and a lens 143 disposed above the LED 142. The lens 143 is accommodated within the lens housing 141. The light from the LED 142 is diffused through the lens 143 above, thereby forming a LED light effect having a wider angle.

An annular protrusion 145 is provided on a top edge of the lens 143, and an annular groove 146 and a buckle 147 corresponding to the annular protrusion 145 are provided inside the top of the lens housing 141. During assembling, there is only a need to correspondingly embed the annular protrusion 145 of the lens 143 into the annular groove 146 and the buckle 147 of the lens housing 141, so that the lens housing 141 can be snap-fitted and fixed to the lens 143. Next, the lens 143 are mounted on the LED 142.

In addition, a plurality of radiating fins 16 that are perpendicular to the lamp cover 15 are evenly arranged below the lamp housing 13, so as to ensure the heat dissipation effect of the hard linear lamp of the present utility model.

The second embodiment of the present utility model will be briefly described below.

Referring to FIG. 8, FIG. 8 is a schematic view of an exploded structure in a curved state according to a second embodiment of the present utility model. In the second embodiment, adjustments are made to an assembly accessory of the fastener 22 and the snap-fitting manner of the elastic piece 30 with the lamp housing 13, so that the hard linear lamp in the present utility model is also suitable for arc-shaped or irregular linear lamping occasions, and may meet different requirements in terms of cost and price as well as installation environment.

The above descriptions are only the preferred embodiments of the present utility model, but the present utility model is not limited to the above-described embodiments, and an embodiment should fall into the protection scope of the present utility model as long as it achieves the technical effect of the present utility model by any same or similar means. The above embodiment is not limited to the technical solution of the embodiment itself, and the embodiments may be combined with each other to form a new embodiment. The above embodiments are only intended to illustrate the technical solution of the present utility model rather than limiting the same. Any modification or equivalent replacement that does not depart from the spirit and scope of the present utility model should be included in the scope of the technical solution of the present utility model.

What is claimed is:

1. A flexibly deformable hard linear lamp, characterized in that it comprises:
a plurality of light source assemblies (10) including a lamp housing (13) and a light emitting assembly (14) accommodated within the lamp housing (13), wherein a first through hole (11) is provided at both ends of the light source assembly (10);
a connection assembly (20) movably connected between two adjacent light source assemblies (10), wherein the connection assembly (20) includes a connecting piece (21) and a fastener (22) disposed at both ends of the connecting piece (21),
wherein the fastener (22) is snap-fitted into an inside of the first through hole (11) of the light source assembly (10), so that the spacing and included angle between two adjacent light source assemblies (10) are adjustable.

2. The flexibly deformable hard linear lamp according to claim 1, characterized in that the connecting piece (21) has a width less than that of the first through hole (11), and the connecting piece (21) has a height less that that of the first through hole (11).

3. The flexibly deformable hard linear lamp according to claim 1, characterized in that a second through hole to accommodate an electric wire and to allow the electric wire pass therethrough is provided at both ends of the light source assembly (10).

4. The flexibly deformable hard linear lamp according to claim 1, characterized in that an arc-shaped protrusion (131) to facilitate heat dissipation is provided at both sides of the lamp housing (13), wherein the arc-shaped protrusion (131) is evenly provided with a plurality of strip-like grooves (132) into which an elastic piece (30) for installation could be snap-fitted.

5. The flexibly deformable hard linear lamp according to claim 1, characterized in that the lamp housing (13) includes a lamp cover (15) removably connected to both ends of the lamp housing (13), wherein a cavity to accommodate the fastener (22) and to allow the movement of the fastener (22) therein is provided at a position within the light source assembly (10) proximate to the lamp cover (15).

6. The flexibly deformable hard linear lamp according to claim 5, characterized in that a plurality of radiating fins (16) perpendicular to the lamp cover (15) are evenly arranged below the lamp housing (13).

7. The flexibly deformable hard linear lamp according to claim 6, characterized in that the light emitting assembly (14) includes an aluminum PCB fixed on the radiating fin (16), an LED (142) soldered on the aluminum PCB, a cylindrical lens housing (141) located above the LED (142), and a lens (143) accommodated within the lens housing (141).

8. The flexibly deformable hard linear lamp according to claim 7, characterized in that an annular protrusion (145) is provided on a top edge of the lens (143), and an annular groove (146) and a buckle (147) corresponding to the annular protrusion (145) are provided inside a top of the lens housing (141), so that the lens housing (141) is fixed with the lens (143) by snap-fitting.

9. The flexible hard linear lamp according to claim 1, wherein the fastener (22) includes a fixing screw (221), a wave washer (222), a plain washer (223), a gasket 224) and an antiskid nut (225).
